(19) United States
(12) Patent Application Publication
(10) Pub. No.: US 2010/0067816 A1
(43) Pub. Date: Mar. 18, 2010

(54) METHOD AND APPARATUS FOR REDUCING MOTION BLUE IN A DISPLAYED IMAGE

(76) Inventor: Geoffrey Howard Blackham, West Sussex (GB)

Correspondence Address: Iandiorio Teska & Coleman, 260 Bear Hill Road, Waltham, MA, 02451, US

(21) Appl. No.: 12/312,795

(22) PCT Filed: Oct. 9, 2007
(86) PCT No.: PCT/GB2007/003829

§ 371 Date: May 27, 2009

(30) Foreign Application Priority Data
Nov. 28, 2006 (GB) 0623769.7

(51) Int. Cl. G06K 9/40

(52) U.S. Cl. 382/255

(57) ABSTRACT

A method for reducing motion blur in a displayed image, comprising utilising at least one first panel (1) and at least one second panel (2), and in which a temporal phase shift is applied between the drive to the first and the second panels (1, 2) such that the bright duration of a picture element is reduced only when it changes in demand value from one video frame to the next. Apparatus for reducing the motion blur in a displayed image is also disclosed, the apparatus comprising primary image modulation means comprising at least one first panel (1), secondary image modulation means comprising at least one second panel (2), a light source (3), transmitting means (4) for transmitting the image from the first panel (1) to the second panel (2), viewing means (5) for viewing the net image transmission through both the first panel (1) and the second panel (2), and video data processing means (6) for providing a relative delay between the drive to the first panel (1) and the second panel (2).

This invention relates to a method and apparatus for reducing motion blur in a displayed image.

Liquid crystal device-based display devices often work on the principle that a pixel, once addressed with its latest demand value, stays at the demanded state of transmission or reflection until it is addressed again. This is often achieved by use of a sample-and-hold circuit built into the display apparatus where one such sample-and-hold circuit exists for each pixel. Typically the pixels are sequentially addressed on each frame period so that the pixel values are “held” between frames. Other schemes may exist that achieve the same result, and where the pixel value is “held”, but that may not use sequential scanning and may not use sample-and-hold circuits. The hold effect causes blur of moving objects in an image to the observer as the human visual system tracks them across the displayed scene. A pixel may be regarded as a display picture element that comprises one or more of the native addressable picture elements in an electronic display light modulator panel. The electronic display light modulator panel may be regarded as an electronic display light modulator device that comprises a number of pixels that may be reflective or transmissive in their light transfer characteristic behaviour and may be of liquid crystal or other technology to impart its behaviour.

It is an aim of the present invention to provide a method and apparatus for reducing motion blur in a displayed image.

Accordingly, in one non-limiting embodiment of the present invention there is provided a method for reducing motion blur in a displayed image, which method comprises utilising at least one first panel and at least one second panel to successively modulate transmitted image light in response to video demand inputs, the first and the second panels exhibiting a hold effect whereby the transmission of each element changes in response to demand input change, characterised in that a temporal phase shift is applied between the drive to the first and the second panels such that the bright duration of a picture element is reduced only when it changes in demand from one video frame to the next.

The method may be one in which the first panel and the second panel are cascaded.

The method exploits the re-modulation that a second panel applies to corresponding image content from the first panel. The method may be applied where there is exact and inexact correlation between the panels' image content, for example they may be pixel-for-pixel correlated or at differing pixel formats that are not pixel-for-pixel.

The method may include applying feed forward compensation to a demand input to the display in order to compensate for changed net light energy transmission in pixels that have changed in value.

The method may be one in which any of the panels are over-driven for at least one frame period to allow use of otherwise unused panel transmission range for panel areas that experience an increase in intensity from a previous frame period.

In a further non-limiting embodiment of the invention there is provided apparatus for reducing motion blur in a displayed image, which apparatus comprises:
(a) primary image modulation means comprising at least one first panel;
(b) secondary image modulation means comprising at least one second panel;
(c) a light source;
(d) transmitting means for transmitting the image from the first panel to the second panel;
(e) viewing means for viewing the net image transmission through both the first panel and the second panel; and
(f) video data processing means for providing a relative delay between the drive to the first panel and the second panel.

The apparatus may be one in which the primary image modulation means comprises two or more of the first panels, and in which the two or more of the first panels provide for colour modulation.

The apparatus may be one in which the direction of light is reversed from the light source to an output.

The transmitting means may be as simple as where the first and second panels are physically close enough or even touching for adequate image content correlation.

The video data processing means may include feed-forward compensation means for modifying pixel demand values that change between frame periods. The feed forward compensation means may include recursive filtering means for providing feed forward compensation over greater than a single frame period after a pixel value has changed.

The feed-forward compensation means may be such that the applied feed forward compensation is linearly related to the difference in input demand. Alternatively, the feed-forward compensation means may be such that the applied feed-forward compensation is non-linearly related to the difference in input demand. The feed-forward compensation means may be such that the applied feed-forward compensation is linearly related to the degree of phase-shift applied to cascaded panel drives. Alternatively, the feed-forward compensation means may be such that the applied feed-forward compensation is non-linearly related to the degree of phase-shift applied to cascaded panels drives. The feed-forward compensation means may be such that the applied feed-forward compensation has one or more thresholds applied to the difference output prior to scaling.

The above mentioned non-linear function may be a power function. Other types of non-linear function may be employed.

The apparatus of the present invention may include multiplier stages in the video signal processing for applying correction factors.

Embodiments of the invention will now be described solely by way of example and with reference to the accompanying drawings in which:

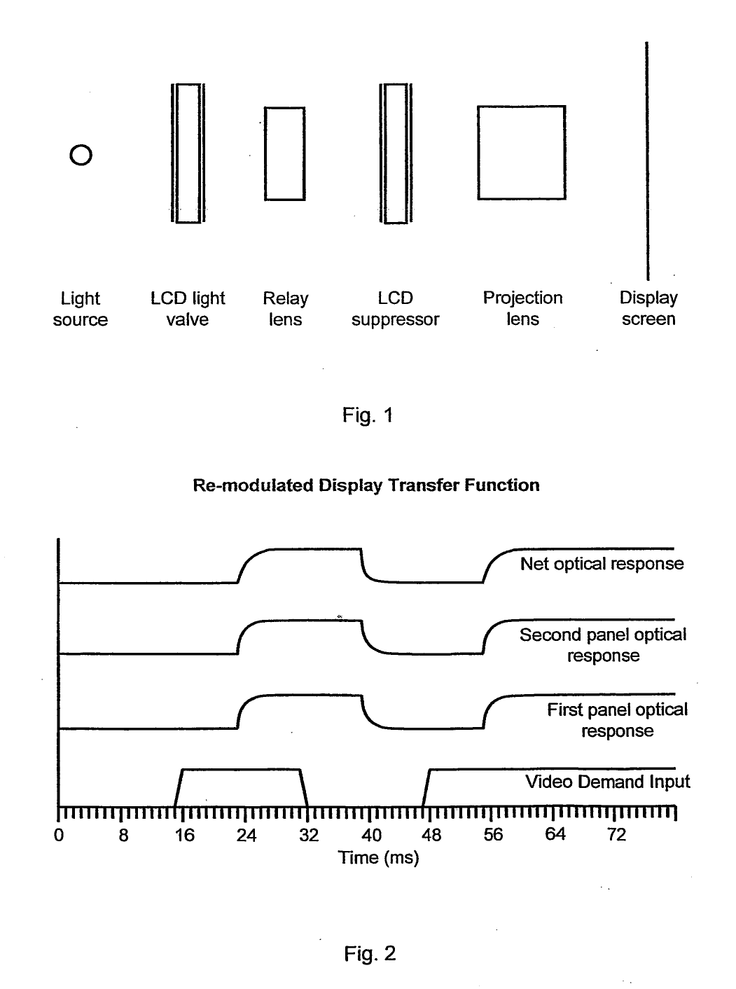

FIG. 1 shows simple two-panel re-modulation apparatus;

FIG. 2 shows an optical response for in-phase re-modulation apparatus;

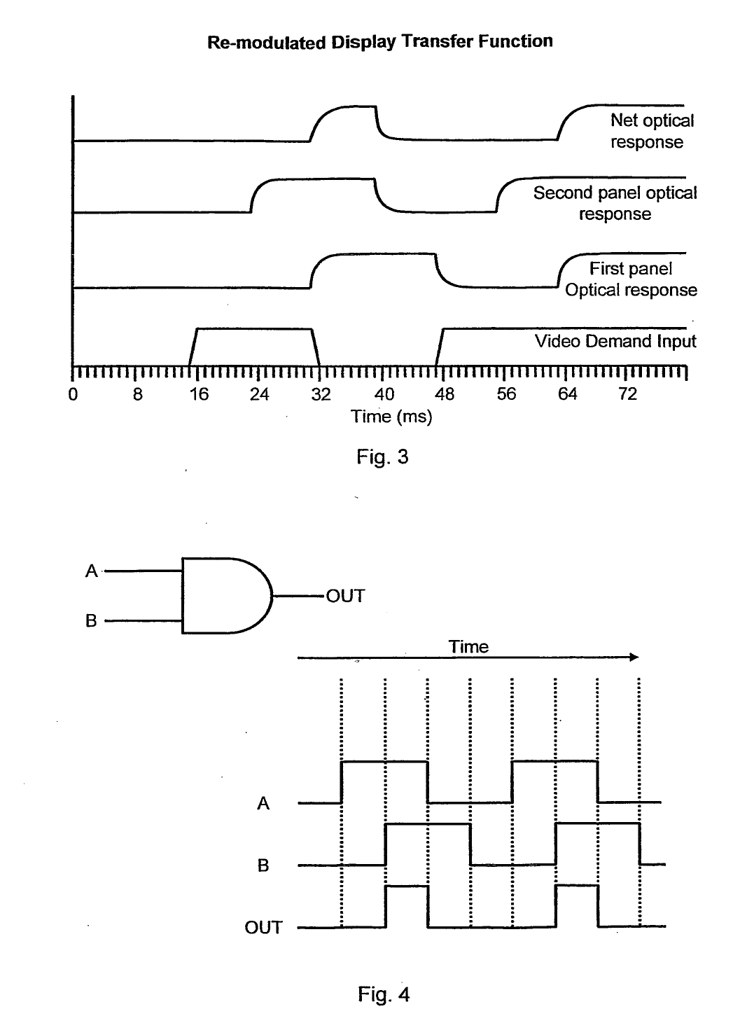

FIG. 3 shows a set of optical responses for shifted phase drive to a first panel;

FIG. 4 illustrates an AND gate analogy;

FIG. 5 illustrates the principle of applying feed-forward compensation for moving content intensity correction;

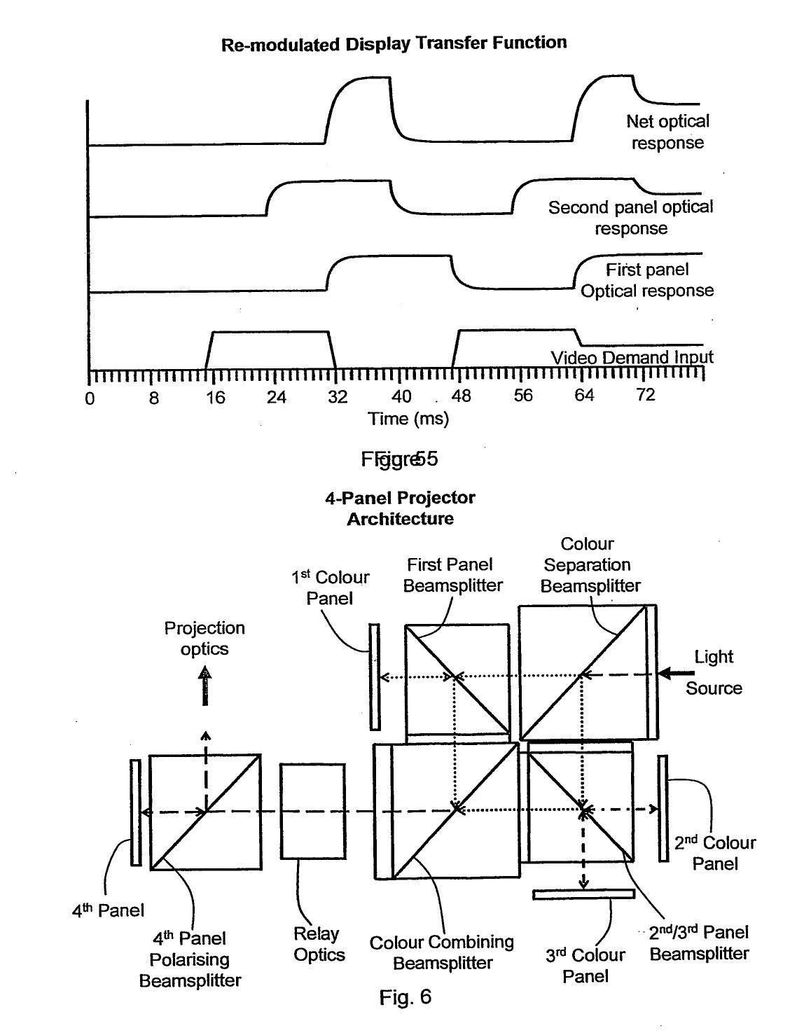

FIG. 6 shows an optical construction of a 4-panel projector;

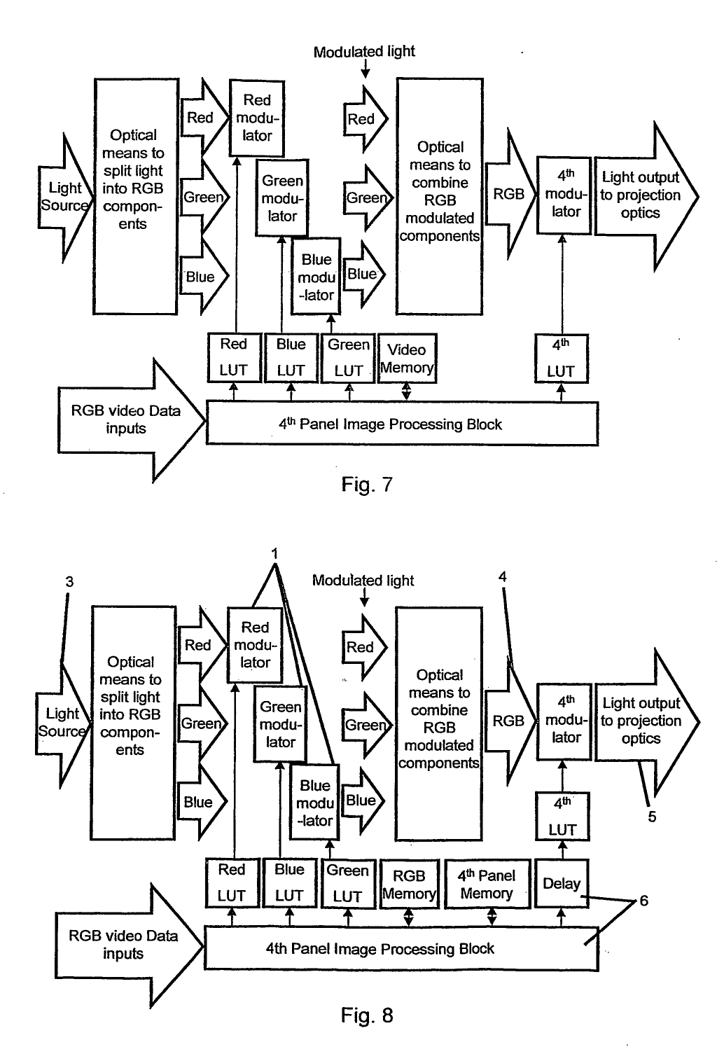

FIG. 7 shows a 4-panel drive construction, and in particular shows how digital video are processed from a 3-colour red, green and blue digital input;

FIG. 8 shows a delay mechanism using video memory to delay the drive to red, greed and blue panels;

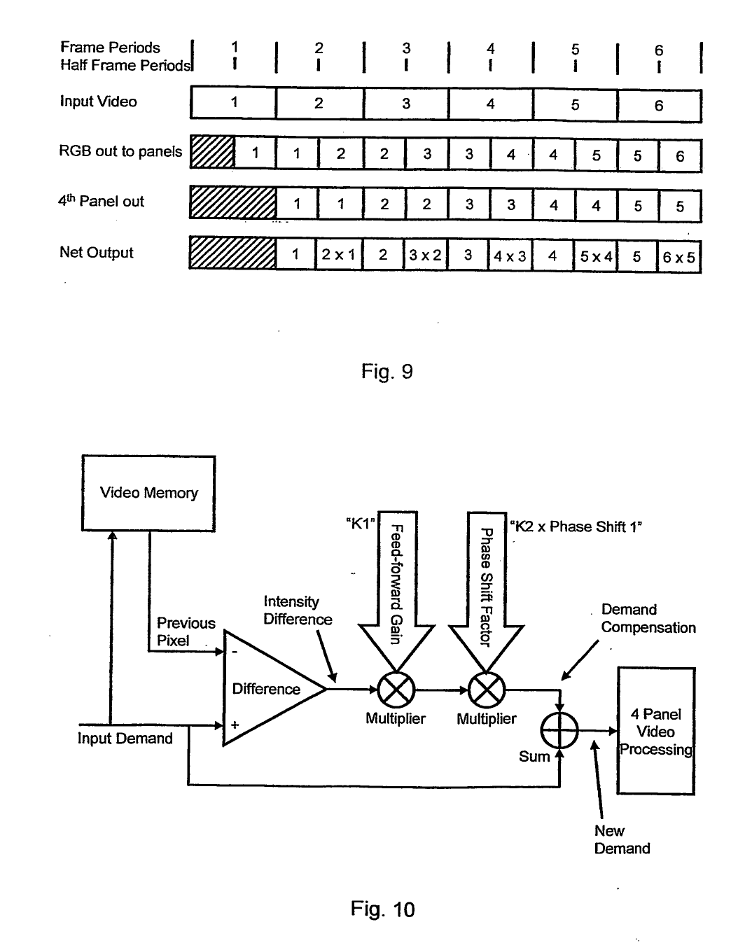

FIG. 9 shows a phase shift timing diagram, which may be associated with the display drive architecture shown in FIG. 8;

FIG. 10 illustrates feed-forward compensation;

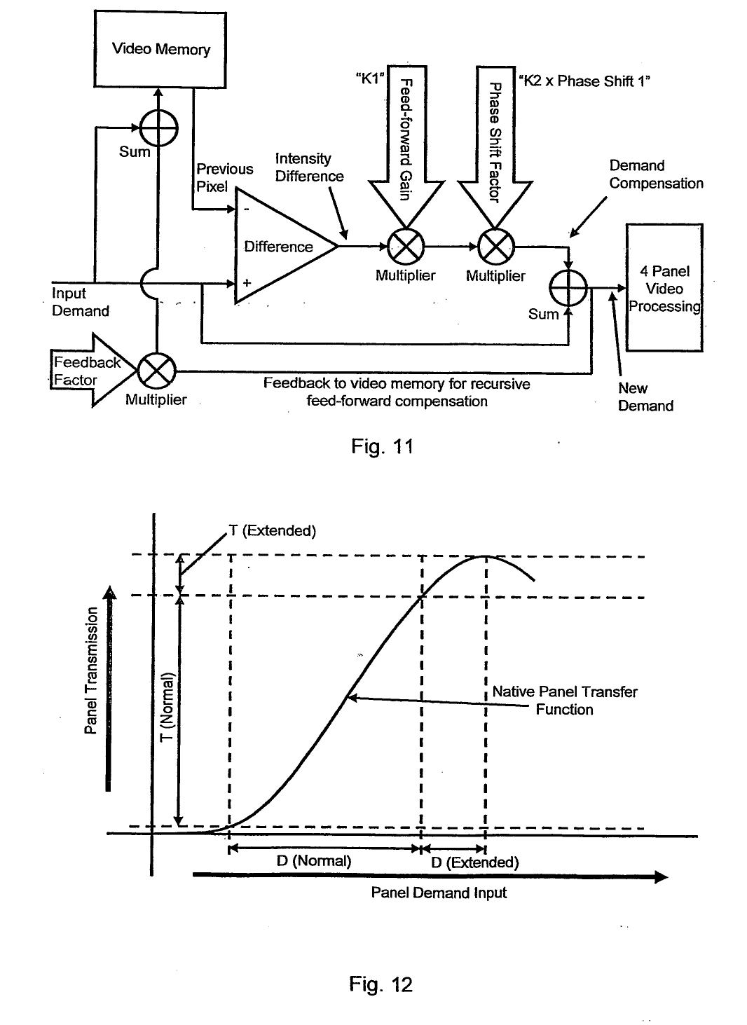

FIG. 11 illustrates compensation with recursive video memory storage; and

FIG. 12 shows an example of panel transfer function and availability of “excess” output characteristic.

Referring now to the drawings, FIG. 1 shows a functional representation only. The liquid crystal display device panels could be of alternative display technology that exhibits a similar hold effect. Also, the panels could be reflective or transmissive. If the panels are transmissive, the relay lens between them may not be required as the degree of blurring between panels may be acceptable for some applications. If the panels are reflective they could be of liquid-crystal-on-silicon type.

FIG. 2 shows apparatus optical response for what is described above with reference to FIG. 1. In FIG. 2, for the purpose of illustration, liquid crystal on silicon panels have been assumed. As can be determined from widely understood principles, liquid crystal on silicon panels are typically addressed twice in a frame period, where the drive to each pixel is exactly reversed from positive to negative (or negative to positive) voltage sense in the second half-frame period, in order to maintain essentially zero average direct current content in the pixel drive and hence prevent damage to the liquid crystal. This drive reversal does not change the polarisation state of the liquid crystal in the pixel however. Thus the optical response for a given pixel applies to the demand from the first time it is addressed in the frame period. It will be appreciated that there is a rise and fall time associated with the liquid crystal response and for the purpose of illustration in FIG. 2, a relatively short rise and fall time has been assumed for the liquid crystal on silicon panels. Whilst the benefit to be described for the present invention may apply when longer rise and fall times are exhibited by the panels, the most benefit is obtained when they are shorter, as available from later-generation panels.

One usual implication of the typical requirement of liquid crystal on silicon panels to be addressed twice in a frame period is that the output pixels cannot start to be addressed until at least half a frame period after arrival of the inputs. The timing scheme of FIG. 2 has assumed this initial delay. A number of frame periods, each of 16 milliseconds, have been included in the graph of FIG. 2, which shows four traces associated with a pixel. Pixel-for-pixel correlation has been assumed for clarity, but it may be appreciated that the principle described will apply where there is general image content correlation between panels. The video demand represents the desired state of the pixel, although it should be appreciated that the drive to the pixel would typically be a pair of pulses that feed into the sample-and-hold circuit. The first panel optical response represents the light transfer function resulting from the first liquid crystal on silicon panel in response to the demand. The second panel optical response represents the light transfer function resulting from the second liquid crystal on silicon panel in response to the demand. Here it can be seen that the two panels respond with essentially identical phase. The net optical response would result as simply the product of the transfer functions and the intensity of the light source. It can be seen that the net optical output is essentially of the same duration for both a bright and a dark period as that of the demand input. This therefore means that the motion blur effect is unaffected by the use of re-modulated display apparatus such as that shown in FIG. 1, where the first and second panels are driven with the same phase.

The motion blurring characteristic is undesirable for many applications of display devices where moving content is important, for example in flight simulator displays or home theatre or cinema systems. The present invention may now be seen to improve the motion blur characteristic problem of displays of the types mentioned for these and other applications.

FIG. 3 shows a set of optical responses where the phase of the drive to the first panel has been shifted in time in this example by 8 milliseconds or half a frame period.

By shifting the phase, the net optical response can be seen to have been changed. The first bright period of the net optical response, responding to the demand input from 16 to 32 milliseconds, does not now rise until after 32 milliseconds instead of 24 milliseconds, yet returns to the dark state at the same time as originally seen in FIG. 2. The second bright period, responding to the demand input from 48 milliseconds onwards, does not now rise until after 64 milliseconds instead of 56 milliseconds. Thus the bright interval periods have been reduced and the dark intervals increased compared to the in-phase example of FIG. 2. It may be helpful to consider that the cascaded panels, by re-modulating, behave together in a similar fashion to a logical AND gate to the optical responses for full-scale transitions of the first and second panels. Ignoring the rise and fall times the width of an AND gate output pulse from two phase-shifted pulse inputs would readily seen to be reduced in width. FIG. 4 illustrates this analogy. With an AND gate, it would not matter if the phase were reversed between inputs A and B, and the same net response would occur. The same is true of the net optical response of the display system if the second panel was phase-shifted instead of the first, or if the order of the panels were reversed in the optical path.

The benefit to applying this phase shift between the demand inputs of the first and second panels is that the bright period is reduced. It is important at this point to recognise that the net output trace represents the variation in intensity of a pixel on the display over a number of frame periods. The changes in demand input therefore represent in some way image content variation and could represent specifically motion of image content, such as a bright light point or the edge of an object that moves. The reduced width of the bright period therefore blurs less to the observer, as the hold period has been reduced. It may be seen that this has the effect of reducing motion blur. Many references exist that describe the benefit of reducing the effective bright period duration, for example Klompenhouwer refers to this as the “Motion Aperture”—Michiel A. Klompenhouwer: Paper presented at SID 2006 Paper 54.1; “Comparison of LCD Motion Blur Reduction Methods Using Temporal Impulse Response and MPRT”. The present invention exploits the characteristic of applying shifted phase to consecutive panels in a re-modulated display system to reduce the effective Motion Aperture.

A potential drawback to the improved display described above is that, as the pixels are illuminated for a reduced period, there is a correspondingly reduced transfer of optical energy to the observer over a frame period. For moving content in an image, this would have the appearance of dimmed light points or high contrast edges as they move. This may be compensated by applying feed forward compensation into the demand input when the pixel value changes from one frame period to the next.

FIG. 5 illustrates the principle of applying feed-forward compensation. The demand input, when increasing in pixel intensity from one frame to the next, is increased by a proportion according to the change in intensity required and the amount of phase shift applied between the first and second panels. One simplified functional representation of this is:

Demand Compensation,

C=K₁×intensity increase×K2×(100%−phase shift %) (Equation 1)

Demand=Demand Input+C (Equation 2)

A more general function for C is:

C=K₁×f1 (intensity increase)×K₂×f₂ (100%−phase shift %) (Equation 3)

K₁ and K₂ are scaling factors that would be chosen to optimise the correction effect. Note that the methods and apparatus described have not attempted to take into account the transfer characteristics of the panels themselves, and it has been assumed that such characteristics would have been accounted for in the signal processing prior to driving the panels to impart the desired net functional responses.

It can be seen from the example in FIG. 5 that the demand input receives compensation for the whole of the bright period between 16 and 32 milliseconds, as this is a single frame period assumed for the example. The second bright period receives compensation for the first bright period only and then settles to the original demand input, which represents a pixel that has not changed in intensity and thus does not represent moving content. The benefit of this compensation can now be appreciated when comparing FIGS. 2, 3 and 5. In FIG. 2 there is no phase shift or compensation and thus exhibits motion blurring. In FIG. 3, the phase shifting has reduced the motion blur but the net optical energy transmitted over the bright period for a pixel that has increased in demand input has reduced. In FIG. 5, feed-forward compensation has been applied to compensate for this net energy transmission reduction and the observer would no longer see a dimming of the associated pixel. Other durations of feed-forward compensation could be applied than the single-frame period described above, such as over multiple frame periods or partial frame periods, by suitable selection of sample timing intervals in the feed-forward compensation signal processing system.

There will now be described apparatus of the present invention that may be used to implement the method of the present invention. The apparatus described is one possible construction but other constructions may be used to achieve the same functions of phase shifting and feed forward compensation. For the example, a 4-panel projection arrangement is used, where the first modulation is now performed by three panels, each panel modulating red, green and blue light before re-modulation is applied by the fourth panel. FIG. 6 illustrates the possible optical architecture of a 4-panel projector. GB-A-2396072 describes how such a projector provides for very high dynamic range in full colour.

A possible variant of the optical architecture reverses the relative locations of the red, green and blue and fourth panels, such that the fourth panel modulates light prior to transmission onto the red, green and blue panels. Another variant could use a different number of panels for the colour modulation, such as four or two, to increase or reduce the available colour range, including that outside the visible spectrum. In some variants, colour separation may not be required, for example where multiple separate colour light sources are available, such as lasers or light emitting diodes. Further colour recombination may not be required, for example if the image convergence is performed at a screen surface and in this case there may be separate secondary modulators for each primary modulator. Other variants may combine some of these possibilities and could use panels of differing pixel size or count. In all of these variants and others that employ image re-modulation, the benefits of the present invention can be achieved. Typically, video data are available in the digital domain, either by use of analogue-to-digital converters on the inputs to the processing electronics, or by direct connection from a suitable digital video graphics source. FIG. 7 shows how digital video are processed from a 3-colour red, green and blue digital input to provide a four-panel demand output, again as described in GB-A-2396072.

The main processing unit, typically implemented in a field programmable gate array, writes to and reads from video memory. It is therefore possible for the timing of the access to the video memory to be delayed or phase shifted relatively between the red, green and blue and 4^{th} panel demand outputs. The amount of delay may be selected by increments or multiples of video line intervals or some other interval, perhaps by use of software-programmable pointers to the memory.

An adaptation to the display drive architecture to implement such a delay is shown in FIG. 8, with an associated timing diagram in FIG. 9. The delay block may be designed around a number of digital data delay architectures, for example using pointers to the video memory, where the pointer may be software-selectable. In the example of FIG. 8, the memory has been arranged to have separate blocks of memory for red, green and blue data as for 4 panel data, although other arrangements would be readily apparent to someone experienced in video processing architectures. The delay function is applied prior to transmission to the 4th panel look-up-table.

Referring now to FIG. 9, the delaying apparatus implements the phase-shifting method described. The example shows that the 4th panel output has been phase-shifted by a half-frame period. The Net Output shown illustrates how the optical output, ignoring panel gamma or transfer function effects, acts as a multiply function. The 4-panel image processing block seen in FIG. 8 can include the feed-forward compensation sub-block, which is a video data processing means that includes a feed-forward compensation function to modify pixel demand values that change between frame periods. For each new pixel demand, this sub-block takes the value of the previous pixel demand input and compares it with the new demand. The output is then scaled as a function of this difference by a set of multipliers that take as inputs scaling factors that could be controlled by software or other means This block, illustrated in FIG. 10, can therefore be seen to implement a function essentially identical to equations 1 and 2 above.

The construction of FIG. 10 is linear in that the difference is scaled by multipliers. The multiplying inputs are also linear as they are either constant in value or scaled according to the degree of phase shift applied. However, non-linear adaptations of this architecture may also be used that provide potential for further enhancement. One simple adaptation would be for the difference output to have limited thresholds. One example of this would be to only apply a difference output when the input demand is greater than the previous pixel value and that for cases where the input demand is equal to or less than the previous pixel no difference signal is generated. This adaptation would apply feed-forward compensation only to increasing input demand and not for reducing demand. To achieve this the feed-forward compensation applied may have one or more thresholds applied to the difference output prior to scaling. Thresholds could also be applied after the scaling prior to the subsequent video processing. Other adaptations could have non-linear functions applied to the difference element, for example by use of a power function of the difference, or to the phase shift factor for example by use of a power function of the phase shift applied. The more general form of the formula for demand compensation in Equation 3 can thus be seen to apply, where the two functions for feed forward gain and phase-shift factor may incorporate at least the non-linear functions described above.

FIG. 11 shows a further adaptation of the feed-forward construction. In this adaptation, the video memory stores a scaled previous pixel value that has a proportion that has been compensated instead of purely previous pixel demand. The coefficient of scaling applied may be zero, in which case the previous pixel is purely that of the previous pixel demand. If the coefficient is positive, the previous pixel applied to the difference element will contain information from the feed-forward compensation from prior frames and thus may be seen to be equivalent to a recursive filter. Such a system would allow for compensation to be effectively applied over a number of frames.

In FIG. 11, there is shown feed-forward compensation architecture with recursive video memory storage.

It may be appreciated that feed-forward compensation can result in saturation where the final demand to the display panel reaches its limit yet the feed-forward compensation would require that more intensity be demanded. This can be at least partially remedied by allowing the drive range to the panel to exceed its normal range, as this normal range normally allows for some unused part of the panel transfer response. FIG. 12 illustrates how this could be achieved.

The example of FIG. 12 assumes the use of a liquid crystal display-type display panel, which could be of a transmissive or reflective type. The D(Normal) input demand range identified represents how a panel may be driven to make use of the most useful part of the panel transfer characteristic to result in the output transmission range T(Normal). It can be seen however, if the input demand range was extended by the amount D(Extended), the output transmission range is extended by the amount T(Extended). Normally this is not a very useful range as it is difficult to obtain incremental intensity steps that progress naturally from the normal range. However, for the purpose of dynamic intensity correction in the event of saturation when using feed-forward compensation, this drawback would be much less evident as it only applies to panel areas that have increased in value from a previous frame period and would settle to have no additional demand when the intensity for that panel area does not change in successive frames.

When it is considered that this further enhancement could be applied to the red, green and blue as well as the fourth panels, a significant degree of additional intensity range may be temporarily available to help the feed-forward compensation method to operate at the brightest extremes of the normal output range of the 4-panel display system.

The benefit of the adapted feed-forward compensation of FIG. 11 can be seen from the above, where the display panel is operating near the saturation limit. The recursive feedback arrangement of FIG. 11 results in correction contributions over a number of frames. Thus, if the pixel intensity demand prior to feed-forward compensation is close to the saturation limit of the display panel small amounts of intensity correction could be applied over a longer time period thus giving the appearance of a correct average illumination to the observer. Recursive filtering is hence applied to provide for feed-forward compensation for greater than a single frame period after a pixel value has changed. The panel over-drive may also be over a number of frame periods as part of the feed-forward compensation function.

The embodiments of the invention described above indicate the advantage of the invention in image display apparatus which uses liquid crystal spatial light modulators to modulate light in projected displays. The method and apparatus of the invention may also be used to reduce motion blur in flat panel displays such for example as direct view liquid crystal displays.

An embodiment of the invention which is a direct view liquid crystal display comprises a primary image modulation means and secondary image modulation means. The primary and secondary image modulation means may be colour image modulation means, for example a panel comprising an array of red, green and blue pixels. Alternatively, either the primary image modulation means or the secondary image modulation means, may be a monochrome image modulation means. The direct view liquid crystal display may also comprise a light source which may be liquid crystal display backlights such as cold cathode lamps or light emitting diodes. The transmitting means may be an array of lenses for transmitting light from the primary panel to the secondary panel, or may not be necessary as the primary panel and the secondary panel may be located such that they are in close proximity to each other or actually touching each other with corresponding pixels aligned. The viewing means for viewing the net image transmission may be a diffusive layer attached to the secondary image modulator such that the light is diffused to produce an image which may be viewed by the viewer. Video data processing means controls the primary and secondary image modulation means such that a relative delay between the drive to the primary and secondary image modulation means or first and second panels is introduced.

In the above embodiment of the invention which is a direct view liquid crystal display, the primary image modulation means and secondary image modulation means are separate modulation means. Transmissive liquid crystal display devices, such as those described may have glass plates on each side of the liquid crystal layer in order to form a sandwich in which the liquid crystal is contained. One of the glass plates may be common to each of the primary image modulation means and secondary image modulation means. Therefore the primary image modulation means and secondary image modulation means may be combined in a single panel whilst maintaining independent operation or modulation of each of the primary and secondary image modulators. The primary and secondary image modulators may have a common glass layer between the liquid crystal layers with independent control.

It is to be appreciated that all the embodiments of the invention described above with reference to the accompanying drawings have been given by way of example only and that modifications may be effected.

1. A method for reducing motion blur in a displayed image, which method comprises utilising at least one first panel and at least one second panel to successively modulate transmitted image light in response to video demand inputs, the first and the second panels exhibiting a hold effect whereby the transmission of each element changes in response to demand input change, characterised in that a temporal phase shift is applied between the drive to the first and the second panels such that the bright duration of a picture element is reduced only when it changes in demand from one video frame to the next.

2. A method according to claim 1 and including applying feed-forward compensation to a demand input to the display in order to compensate for changed net light energy transmission in pixels that have changed in value.

3. A method according to claim 1 in which the first panel
and the second panel are cascaded.

4. A method according to claim 1 in which any of the panels are over-driven for at least one frame period to allow use of otherwise unused panel transmission range for panel areas that experience an increase in intensity from a previous frame period.

5. (canceled)

6. Apparatus for reducing motion blur in a displayed image, which apparatus comprises:
(a) primary image modulation means comprising at least one first panel;
(b) secondary image modulation means comprising at least one second panel;
(c) a light source;
(d) transmitting means for transmitting the image from the first panel to the second panel;
(e) viewing means for viewing the net image transmission through both the first panel and the second panel; and
(f) Video data processing means for providing a relative delay between the drive to the first panel and the second panel.

7. Apparatus according to claim 6 in which the primary image modulation means comprises two or more of the first panels, and in which the two or more of the first panels provide for colour modulation.

8. Apparatus according to claim 6 in which the direction of light transmission is reversed from the light source to an output.

9. Apparatus according to claim 6 in which the video data processing means includes feed-forward compensation means for modifying pixel demand values that change between frame periods.

10. Apparatus according to claim 9 in which the feed-forward compensation means includes recursive filtering means for providing feed-forward compensation over greater than a single frame period after a pixel value has changed.

11. Apparatus according to claim 9 in which the feed-forward compensation means is such that the applied feed-forward compensation is linearly related to the difference in input demand.

12. Apparatus according to claim 9 in which the feed-forward compensation means is such that the applied feed-forward compensation is non-linearly related to the difference in input demand.

13. Apparatus according to claim 9 in which the feed-forward compensation means is such that the applied feed-forward compensation is linearly related to the degree of phase-shift applied between the first and second panel drives.

14. Apparatus according to claim 9 in which the feed-forward compensation means is such that the applied feed-forward compensation is non-linearly related to the degree of phase shift applied between the first and second panel drives.

15. Apparatus according to claim 9 in which the feed-forward compensation means is such that the applied feed-forward compensation has one or more thresholds applied to the difference output prior to scaling.

16. Apparatus according to claim 12 in which the non-linear function is a power function.

17. Apparatus according to claim 6 and including multiplier stages in the video signal processing for applying correction factors.
